(19) United States
(12) Patent Application Publication
(10) Pub. No.: US 2007/0209683 A1
(43) Pub. Date: Sep. 13, 2007

(54) Method for cleaning reactor and method for manufacturing a chip thereof

(75) Inventors: Chih-Neng Chou, Hsin-chu (TW); Hung-Hu Hao, Hsin-chu (TW); Kuo-Pang Tseng, Hsin-chu (TW)

Correspondence Address: BIRCH STEWART KOLASCH & BIRCH, PO BOX 747, FALLS CHURCH, VA, 22040-0747, US

(73) Assignee: MACRONIX INTERNATIONAL CO., LTD.

(21) Appl. No.: 11/373,244

(22) Filed: Mar. 13, 2006

(51) Int. Cl. B08B 5/04; B08B 9/00

(52) U.S. Cl. 134/21; 134/22.1

(57) ABSTRACT

A method for cleaning a reactor and a method for manufacturing a chip thereof are provided. The reactor at least includes a reaction cavity and an inner tube. The inner tube is disposed inside the reaction cavity. The wall of the inner tube has a foreign particle. In the cleaning method, firstly, a continuous fluid is induced into and out of the reaction cavity. Next, the pressure of the continuous fluid is adjusted to be within a range from 100 torr to 300 torr for removing and taking the foreign particle out of the reaction cavity.

This application incorporates by reference Taiwanese application Serial No. 95104094

### BACKGROUND OF THE INVENTION

1. Field of the Invention

The invention relates in general to a method for cleaning a reactor and a method for manufacturing a chip thereof, and more particularly to a method of cleaning the reactor using a low-pressured continuous fluid and a method for manufacturing a chip thereof.

2. Description of the Related Art

The semiconductor industry is experiencing rapid growth. In addition to the pursuit of a higher quality of semiconductor products, the semiconductor industry is also aiming at further reducing manufacturing costs so as to achieve higher profit. Examples of the semiconductor products include a wafer. The wafer requires a reactor device, such as a reactor tube for instance, to perform the wafer surface deposition manufacturing process, such as a low pressure chemical vapor deposition (LPCVD) manufacturing process for instance. Therefore, the quality of the chip has much to do with the quality and the control of the reactor. However, most of the reactors, after a certain times of use, face the same problem of the deposition of a foreign particle on the reactor. The deposition of foreign particle normally occurs due to the deposition of the reactant source gas on a non-chip surface. For example, the deposition on the surface of a reactor inner tube, a boat, a pin or a manifold, forms an undesired particle or membrane. Therefore, it is essential to resolve the problem of the deposition of foreign particle inside the reactor.

According to a conventional method for cleaning a reactor, the reactor inner tube is replaced periodically. Normally, after a certain times of use, the foreign particle deposited on the inner tube of the reactor will achieve a certain thickness. At that time, the reactor is halted, and the elements inside the reactor such as the boat, the pin, the manifold and so on are removed sequentially. And then, the inner tube is removed from the reactor, the foreign particle such as particle or membrane deposited on the inner tube is cleaned. Not until another inner tube is placed into the reactor can the reactor be used again. The above cleaning method is inefficient and has several disadvantages. The method requires many complicated steps, the replacement cost of the reactor inner tube is required, but the lifespan of the reactor can not be prolonged.

### SUMMARY OF THE INVENTION

It is therefore an object of the invention to provide a method for cleaning a reactor and a method for manufacturing a chip thereof. By introducing a continuous fluid into and out of the reactor and cleaning the reactor under low pressure, the lifespan of the reactor inner tube is increased.

The invention achieves the above-identified object by providing a reactor cleaning method. The reactor at least includes a reaction cavity and an inner tube. The inner tube is disposed inside the reaction cavity. The wall of the inner tube has a foreign particle. In the cleaning method, firstly, a continuous fluid is induced into and out of the reaction cavity. Next, the pressure of the continuous fluid is adjusted to be within a range from 100 torr to 300 torr for removing and taking the foreign particle out of the reaction cavity.

The invention further achieves the above-identified object by providing a method of cleaning a reactor. The reactor at least includes a reaction cavity and an inner tube. The inner tube is disposed inside the reaction cavity and has a boat exit opening. The wall of the inner tube has a foreign particle. In the cleaning method, firstly, a boat carrier is used to seal the boat exit opening. Next, a continuous fluid is induced into and out of the reaction cavity. Then, the pressure of the continuous fluid is adjusted to be within a range from 100 torr to 300 torr for removing and taking the foreign particle out of the reaction cavity. Next, after a cleaning time, the continuous fluid is no longer introduced into the reaction cavity. Then, the boat carrier is removed.

The invention further achieves the above-identified object by providing a chip manufacturing method. Firstly, a reactor at least including a reaction cavity and an inner tube is provided. The inner tube is disposed inside the reaction cavity and has a boat exit opening. The wall of the inner tube has a foreign particle. Then, a boat carrier is used to seal the boat exit opening. Next, a continuous fluid is induced into and out of the reaction cavity. Then, the pressure of the continuous fluid is adjusted to be within a range from 100 torr to 300 torr for removing and taking the foreign particle out of the reaction cavity. Next, after a cleaning time, the continuous fluid is no longer introduced into the reaction cavity. Then, the boat carrier is removed. Next, a wafer is placed on a boat. Then, the boat is placed on the boat carrier. The boat carrier is used to seal the boat exit opening again to place the boat inside the reaction cavity. Next, a reactant source gas is infused into the reaction cavity to proceed the semiconductor manufacturing process of the wafer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a flowchart of a method of manufacturing a chip according to a preferred embodiment of the invention;

FIG. 2 is a diagram of a reactor according to the preferred embodiment of the invention; and

FIG. 3 is a residual statistic chart of foreign particle according to whether a low-pressured continuous fluid is used to clean the foreign particle in a preferred embodiment of the invention.

### DETAILED DESCRIPTION OF THE INVENTION

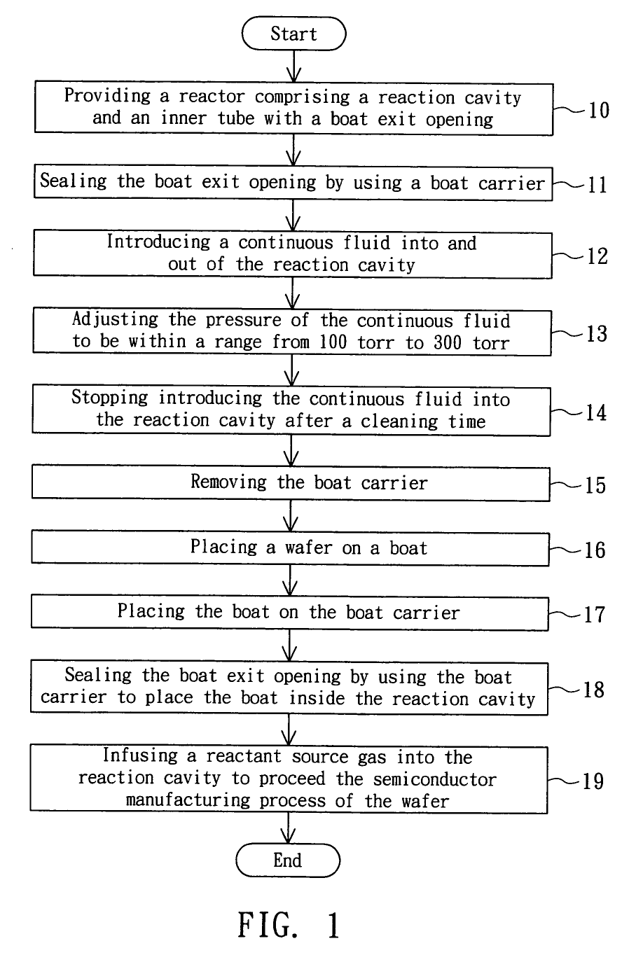

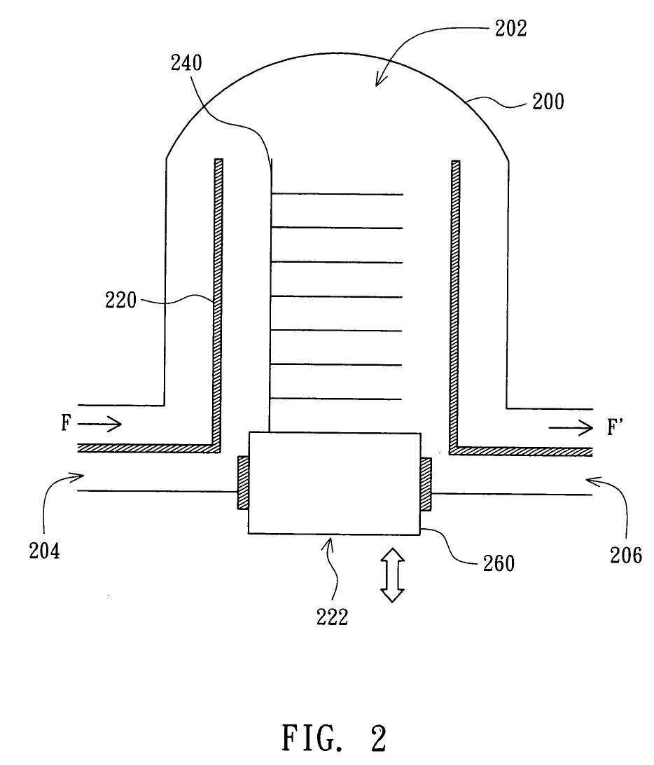

Referring to FIG. 1, a flowchart of a method of manufacturing a chip according to a preferred embodiment of the invention is shown. Referring to FIG. 2, a diagram of a reactor according to a preferred embodiment of the invention is shown.

During the process of manufacturing a chip, undesired foreign particles occur easily. Therefore, during the process of using a reactor to manufacture the chip, a reactor cleaning method, a method of cleaning the reactor under low pressure in particular, is used for removing the foreign particle inside the reactor first, and then the semiconductor manufacturing process of the wafer is performed.

Firstly, as shown in step 10, a reactor 200 having a reaction cavity 202 and an inner tube 220 is provided. The inner tube 220 has a boat exit opening 222. A reactant source gas of the wafer deposition manufacturing process such as silane (SiH₄) and ammonia (NH₃) can be infused into the reaction cavity 202 via a device entrance 204 for the processing of low pressure chemical vapor deposition (LPCVD) manufacturing process, and then the reactant source gas is discharged via a device exit 206. After the reactor 200 has been used for a number of times, the foreign particle generated from the reactant source gas is likely to be deposited on the wall of the inner tube 220 in the form of a particle or a membrane. Before cleaning the foreign particle from the reactor 200, a boat 240 is removed first.

Next, as shown in step 11, a boat carrier 260 is used to seal the boat exit opening 222. The source of a continuous fluid F is connected to the device entrance 204 for providing the continuous fluid F, while a dry pump is connected to the device exit 206 for activating the flow of the continuous fluid F and adjusting the pressure of the continuous fluid F.

Then, proceed to step 12, the continuous fluid F is pumped into and discharged from the reactor 200 by a dry pump, and the preparation for removing the foreign particle deposited on the wall of the inner tube 220 is ready. Meanwhile, the continuous fluid F is continuously introduced into the reaction cavity 202 via the device entrance 204, flows through the inner tube 220, and is discharged from the reaction cavity 202 via the device exit 206. The continuous fluid F fills up the reaction cavity 202 and contacts the inner tube 220.

Next, proceed to step 13, the pressure of the continuous fluid F is adjusted by the dry pump to be within a range preferably from 100 torr to 300 torr for removing the foreign particle deposited on the wall of the inner tube 220 and take the foreign particle out of the reaction cavity 202. The pressure of the continuous fluid F can range from 150 torr to 250 torr. In the present method, the low-pressured continuous fluid F is used to lash the foreign particle deposited on the wall of the inner tube 220 for enabling the foreign particle to be peeled off the wall and taken out of the reaction cavity 200 by the continuous fluid F′. The continuous fluid F is a pure continuous fluid does not include any foreign particles, while the continuous fluid F′ includes the foreign particle peeled off the wall of the inner tube 220. To avoid unnecessary reaction, the introduced continuous fluid F is preferably a fluid not reacting with the foreign particle. For example, the continuous fluid includes inert gas or nitrogen.

Then, proceed to step 14, after the continuous fluid F has been cleaning the reactor 200a for a cleaning time, the source of the dry pump and the continuous fluid F can be turned off to stop introducing the continuous fluid F into the reaction cavity 202. The present method controls the cleaning time to be within the range from 10 minutes to 30 minutes, and preferably 20 minutes. The particle remove rate is proportional to the pressure and the cleaning time of the continuous fluid F. The higher the pressure of the continuous fluid F is, or the longer the continuous fluid F is introduced (the cleaning time), the more molecules of the foreign particle are contacted and taken away by the continuous fluid F. Under the ideal conditions when the pressure of the continuous fluid is 200 torr, the cleaning time is 20 minutes, and the temperature is 400±10?, the method achieves best effect in cleaning the foreign particle.

Next, proceed to step 15, the boat carrier 260 is removed, and the cleaning of the reactor 200 is completed. Step 11 to step 15 form the process of cleaning the reactor.

In order to further improve the cleaning effect, the difference in the thermal expansion coefficient between the inner tube 220 and the foreign particle can be used to facilitate peeling the foreign particle off. The larger the difference in the thermal expansion coefficient between the inner tube 220 and the foreign particle, the better the foreign particle is peeled off. If the foreign particle is a nitride whose thermal expansion coefficient is 5, then the material of the inner tube 220 is preferably silicon carbide (SiC) whose thermal expansion coefficient is 4.5 or quartz (SiO₂) whose thermal expansion coefficient is 0.54.

After the method of cleaning the reactor is completed, a large amount of foreign particles are removed from the reactor 200, so the reactor 200 can be used in the wafer deposition manufacturing process for manufacturing the chip.

Then, proceed to step 16, a wafer is placed in the boat 240 and the preparation for the wafer deposition manufacturing process is ready.

Next, proceed to step 17, the boat 240 is placed on the boat carrier 260.

Then, proceed to step 18, the boat carrier 260 is used to seal the boat exit opening 222 again to place the boat 260 inside the reaction cavity 202. After the wafer is spread over the boat 240 and the boat 240 is placed into the reaction cavity 202 via the boat exit opening 222, the boat exit opening 222 is sealed by the boat carrier 260.

Next, proceed to step 19, a reactant source gas is infused into the reaction cavity 202 to proceed the semiconductor manufacturing process of the wafer, such as a wafer deposition manufacturing process for instance. After the source of the gas of reactant source gas is connected to the device entrance 204, a reactant source gas, such as silane (SiH₄) and ammonia (NH₃) is infused to start the low pressure chemical vapor deposition (LPCVD) manufacturing process. After a response time, the wafer surface generates a membrane, such as silicon nitride (SiN3). The manufacturing of the chip is completed.

According to the cleaning method disclosed in the preferred embodiment of the invention, after cleaning is completed, the foreign particle inside the reactor is examined. The examining step includes: (1) placing a control wafer on the boat 240; (2) filling up the pseudo wafer or dummy wafer over the boat 240; (3) performing the wafer deposition manufacturing process; and (4) removing the wafer to be observed by a microscopy to estimate the number of foreign particle (particles) deposited on the wafer and record the examination data accordingly.

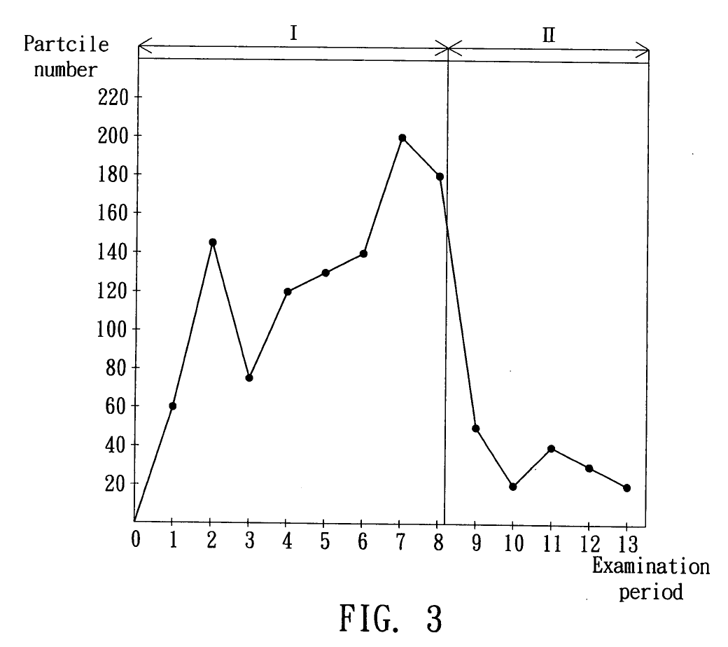

Referring to FIG. 3, a residual statistic chart of foreign particle according to whether a low-pressured continuous fluid is used to clean the foreign particle in a preferred embodiment of the invention is shown. As shown in FIG. 3, segment I illustrates the examination data of foreign particle after a conventional cleaning method is performed. It can be seen that the observed number of the foreign particle of the reactor is too high, which implies that the reactor contains a large amount of foreign particles and is not suitable to be used in the wafer deposition manufacturing process. Segment 11 illustrates the examination data of foreign particle after the cleaning method of the invention is performed. It can be seen that the observed number of the foreign particle of the reactor is reduced, which implies that the reactor contains a small amount of foreign particles and is suitable to be used in the wafer deposition manufacturing process. That is, the cleaning method of invention increases the particle remove rate by 3% to 50%, and can remove the foreign particle deposited on the reactor effectively.

According to method for cleaning a reactor disclosed in above embodiments of the invention, the reactor inner tube does not need to be removed from the reactor, a continuous fluid is introduced, and the pressure of the continuous fluid and the cleaning time are both controlled. By introducing the continuous fluid to interact with the foreign particle and by using the difference in the expansion coefficients between the inner tube and the foreign particle, not only can the foreign particle deposited on the reaction cavity is effectively removed, but also the lifespan of the reactor is prolonged and the device cost is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for cleaning a reactor, wherein the reactor at least comprises a reaction cavity and an inner tube, the inner tube is disposed inside the reaction cavity, the wall of the inner tube has a foreign particle, and the method comprises:
introducing a continuous fluid into and out of the reaction cavity; and
adjusting the pressure of the continuous fluid to be within a range from 100 torr to 300 torr for removing and taking the foreign particle out of the reaction cavity.

2. The method according to claim 1, wherein the pressure of the continuous fluid ranges from 150 torr to 250 torr.

3. The method according to claim 2, wherein the pressure of the continuous fluid is 200 torr.

4. The method according to claim 1, wherein the continuous fluid includes inert gas.

5. The method according to claim 1, wherein the continuous fluid includes nitrogen gas.

6. The method according to claim 1, further comprising:
stopping introducing the continuous fluid into and out of the reaction cavity after a cleaning time.

7. The method according to claim 6, wherein the cleaning time ranges from 10 minutes to 30 minutes.

8. The method according to claim 7, wherein the cleaning time is 20 minutes.

9. A method for cleaning a reactor, wherein the reactor at least comprises a reaction cavity and an inner tube, the inner tube is disposed inside the reaction cavity, the inner tube has a boat exit opening, the wall of the inner tube has a foreign particle, and the method comprises:
sealing the boat exit opening by using a boat carrier;
introducing a continuous fluid into and out of the reaction cavity;
adjusting the pressure of the continuous fluid to be within a range from 100 torr to 300 torr for removing and taking the foreign particle out of the reaction cavity;
stopping introducing the continuous fluid into the reaction cavity after a cleaning time; and
removing the boat carrier.

10. The method according to claim 9, wherein the pressure of the continuous fluid ranges from 150 torr to 250 torr.

11. The method according to claim 10, wherein the pressure of the continuous fluid is 200 torr.

12. The method according to claim 9, wherein the continuous fluid includes inert gas.

13. The method according to claim 9, wherein the continuous fluid includes nitrogen gas.

14. The method according to claim 9, wherein the cleaning time ranges from 10 minutes to 30 minutes.

15. A chip manufacturing method, comprising:
providing a reactor comprising a reaction cavity and an inner tube, wherein the inner tube is disposed inside the reaction cavity, the inner tube has a boat exit opening, and the wall of the inner tube has a foreign particle;
sealing the boat exit opening by using a boat carrier;
introducing a continuous fluid into and out of the reaction cavity;
adjusting the pressure of the continuous fluid to be within a range from 100 torr to 300 torr for removing and taking the foreign particle out of the reaction cavity;
stopping introducing the continuous fluid into the reaction cavity after a cleaning time;
removing the boat carrier;
placing a wafer on a boat;
placing the boat on the boat carrier;
sealing the boat exit opening by using the boat carrier to place the boat inside the reaction cavity; and
infusing a reactant source gas into the reaction cavity to proceed the semiconductor manufacturing process of the wafer.

16. The method according to claim 15, wherein the pressure of the continuous fluid ranges from 150 torr to 250 torr.

17. The method according to claim 16, wherein the pressure of the continuous fluid is 200 torr.

18. The method according to claim 15, wherein the continuous fluid includes inert gas.

19. The method according to claim 15, wherein the continuous fluid includes nitrogen gas.

20. The method according to claim 15, wherein the cleaning time ranges from 10 minutes to 30 minutes.
